(19) United States
(12) Patent Application Publication
(10) Pub. No.: US 2024/0087038 A1
(43) Pub. Date: Mar. 14, 2024

(54) SECURE METAVERSE INSURANCE KIOSKS

(71) Applicant: STATE FARM MUTUAL AUTOMOBILE INSURANCE COMPANY, Bloomington, IL (US)

(72) Inventors: Joseph Robert Brannan, Bloomington, IL (US); Brian N. Harvey, Bloomington, IL (US); Edward W. Breitweiser, Bloomington, IL (US); Joseph P. Harr, Bloomington, IL (US)

(21) Appl. No.: 18/124,168

(22) Filed: Mar. 21, 2023

Related U.S. Application Data
(60) Provisional application No. 63/409,461, filed on Sep. 23, 2022.
(60) Provisional application No. 63/406,628, filed on Sep. 14, 2022.

(51) Int. Cl. G06Q 40/08; G06Q 20/38; G06Q 20/40

(52) U.S. Cl. CPC G06Q 40/08; G06Q 20/3821; G06Q 20/3829; G06Q 20/40145; G06Q 2220/00

(57) ABSTRACT

The following relates generally to providing a virtual insurance kiosk within a virtual environment. In some embodiments, an insurance server receives authentication credentials of a user device attempting to interact with the virtual insurance kiosk. The insurance server may authenticate the user device and establish a secure connection to the user device. The insurance server may then provide an insurance service to the user device. The following also relates generally to providing a secure virtual mall within a virtual environment. In some embodiments, a mall server receives authentication credentials from a user device and/or a vender server. The mall server may then authenticate the user to establish secure connection(s) to the user device and/or vender server. The mall server may process transactions between the user device and vender server, such as by underwriting insurance products related to the transactions.

### CROSS REFERENCE TO RELATED APPLICATIONS

This application claims the benefit of (1) U.S. Provisional Patent Application No. 63/406,628, entitled “Secure Metaverse Insurance Kiosks And Malls,” filed Sep. 14, 2022, and (2) U.S. Provisional Patent Application No. 63/409,461, entitled “Secure Metaverse Insurance Kiosks And Malls,” filed Sep. 23, 2022. U.S. Provisional Patent Application No. 63/406,628 and U.S. Provisional Patent Application 63/409,461 are hereby expressly incorporated by reference herein in their entirety.

### FIELD

The present disclosure generally relates to virtual environments. More particularly, the present disclosure relates to providing a virtual insurance kiosk and/or a secure virtual mall within a virtual environment.

### BACKGROUND

Many virtual environments (e.g., metaverses, etc.) are rapidly expanding. However, many virtual environments do not provide adequate security for particular types of transactions, and/or do not adequately determine which types of transactions should receive additional security. Moreover, people are spending vast amounts of time and money to purchase and/or build virtual items and/or characters, only to later lose those items and/or characters due to data corruption and/or security breaches.

In the real-world, in separate challenges, an insurance policy holder may find it difficult to place an insurance claim, and/or list items that need to be replaced when placing the insurance claim.

The systems and methods disclosed herein provide solutions to these problems and others.

### SUMMARY

The present embodiments relate to, inter alia, providing a virtual insurance kiosk within a virtual environment. For example, a user-controlled character (e.g., a character controlled by a user device, and/or represented by an avatar, etc.) traveling through a virtual environment may visit the virtual insurance kiosk. The character may then log into the virtual insurance kiosk, and a secure connection may then be established between a user device controlling the character, and an insurance server providing the virtual insurance kiosk. Advantageously, the secure connection may provide an additional layer of security not present in other parts of the virtual environment.

Once the secure connection is established, the user device may perform particular kinds of transactions, which are advantageously protected by the additional layer of security. For example, the virtual insurance kiosk may provide: (i) an offer to purchase insurance for a virtual item, (ii) an offer to purchase insurance for a real-world item, (iii) training related to an insurance product, and/or (iv) a service for filing an insurance claim.

In one aspect, a computer-implemented method for providing a virtual insurance kiosk within a virtual environment may be provided. The method may include: (1) receiving, via one or more processors, authentication credentials associated with a user that is attempting to interact with the virtual insurance kiosk within the virtual environment; (2) authenticating, via the one or more processors, the user based upon the authentication credentials; (3) in response to the authentication, establishing, via the one or more processors, a secure connection between a user device of the user and the one or more processors, wherein the establishing the secure connection includes providing a layer of security to support the secure connection between the user device and the virtual insurance kiosk; and/or (4) providing, via the one or more processors and via the secure connection, an offer for an insurance service to the user device connected to the virtual insurance kiosk, wherein the insurance service comprises at least one of: (i) a quote for purchase of insurance for a virtual item, (ii) a quote for purchase of insurance for a real-world item, (iii) training related to an insurance product, and/or (iv) a service for filing an insurance claim. The method may include additional, fewer, or alternate actions, including those discussed elsewhere herein.

In another aspect, a computer system configured to provide a virtual insurance kiosk within a virtual environment, the computer system comprising one or more processors configured to: (1) receive authentication credentials associated with a user that is attempting to interact with the virtual insurance kiosk within the virtual environment; (2) authenticate the user based upon the authentication credentials; (3) in response to the authentication, establish a secure connection between a user device of the user and the one or more processors, wherein the establishing the secure connection includes providing a layer of security to support the secure connection between the user device and the virtual insurance kiosk; and/or (4) provide, via the secure connection, an offer for an insurance service to the user device connected to the virtual insurance kiosk, wherein the insurance service comprises at least one of: (i) a quote for purchase of insurance for a virtual item, (ii) a quote for purchase of insurance for a real-world item, (iii) training related to an insurance product, and/or (iv) a service for filing an insurance claim. The computer system may include additional, less, or alternate functionality, including that discussed elsewhere herein.

In yet another aspect, computer device configured to provide a virtual insurance kiosk within a virtual environment may be provided. The computer device may include: one or more processors; and/or one or more memories coupled to the one or more processors. The one or more memories including computer executable instructions stored therein that, when executed by the one or more processors, may cause the one or more processors to: (1) receive authentication credentials associated with a user that is attempting to interact with the virtual insurance kiosk within the virtual environment; (2) authenticate the user based upon the authentication credentials; (3) in response to the authentication, establish a secure connection between a user device of the user and the one or more processors, wherein the establishing the secure connection includes providing a layer of security to support the secure connection between the user device and the virtual insurance kiosk; and/or (4) provide, via the secure connection, an offer for an insurance service to the user device connected to the virtual insurance kiosk, wherein the insurance service comprises at least one of: (i) a quote for purchase of insurance for a virtual item, (ii) a quote for purchase of insurance for a real-world item, (iii) training related to an insurance product, and/or (iv) a service for filing an insurance claim. The computer device may include additional, less, or alternate functionality, including that discussed elsewhere herein.

The present embodiments also relate to, inter alia, providing a secure virtual mall. For example, a secure virtual mall may be created within the virtual environment where venders sell virtual items and/or real-world items to users. The secure virtual mall may provide an additional layer of security, and advantageously reduce and/or prevent snooping by various entities. Also advantageously, transactions conducted within the secure virtual mall may be underwritten; and periodic backups of items in the secure virtual mall, and/or of the entire secure virtual mall may also be created.

In one aspect, a computer-implemented method for providing a secure virtual mall within a virtual environment may be provided. The method may include: (1) receiving, via one or more processors, user authentication credentials associated with a user that is attempting to interact with the secure virtual mall within the virtual environment; (2) authenticating, via the one or more processors, the user based upon the user authentication credentials; (3) in response to the authentication of the user device, establishing, via the one or more processors, a secure connection between the user device and the one or more processors, wherein the establishing the secure connection includes providing a layer of security within the secure connection between the user device and the secure virtual mall; and/or (4) processing, via the one or more processors, a transaction of the user device occurring in the secure virtual mall, wherein the transaction is between the user device and a vender and is facilitated via the secure connection. The method may include additional, fewer, or alternate actions, including those discussed elsewhere herein.

In another aspect, a computer system configured to provide a secure virtual mall within a virtual environment, the computer system comprising one or more processors configured to: (1) receive user authentication credentials associated with a user that is attempting to interact with the secure virtual mall within the virtual environment; (2) authenticate the user based upon the user authentication credentials; (3) in response to the authentication of the user device, establish a secure connection between the user device and the one or more processors, wherein the establishing the secure connection includes providing a layer of security within the secure connection between the user device and the secure virtual mall; and/or (4) processes a transaction of the user device occurring in the secure virtual mall, wherein the transaction is between the user device and a vender and is facilitated via the secure connection. The computer system may include additional, less, or alternate functionality, including that discussed elsewhere herein.

In yet another aspect, computer device configured to provide a secure virtual mall within a virtual environment may be provided. The computer device may include: one or more processors; and/or one or more memories coupled to the one or more processors. The one or more memories including computer executable instructions stored therein that, when executed by the one or more processors, may cause the one or more processors to: (1) receive user authentication credentials associated with a user that is attempting to interact with the secure virtual mall within the virtual environment; (2) authenticate the user based upon the user authentication credentials; (3) in response to the authentication of the user device, establish a secure connection between the user device and the one or more processors, wherein the establishing the secure connection includes providing a layer of security within the secure connection between the user device and the secure virtual mall; and/or (4) processes a transaction of the user device occurring in the secure virtual mall, wherein the transaction is between the user device and a vender and is facilitated via the secure connection. The computer device may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an exemplary computer system for providing a virtual insurance kiosk.

FIG. 2 depicts an exemplary virtual character in a virtual environment standing at a virtual insurance kiosk with a virtual sales person standing within the virtual kiosk.

FIG. 3 depicts an exemplary signal diagram for providing a virtual insurance kiosk, according to one embodiment.

FIG. 4 depicts an exemplary virtual house prepopulated with items.

FIG. 5 illustrates an exemplary computer-implemented method for providing a virtual insurance kiosk, according to one embodiment.

FIG. 6 depicts an exemplary computer system for providing a secure virtual mall.

FIG. 7 illustrates an exemplary virtual character in a virtual environment standing at an entrance of an exemplary secure virtual mall.

FIG. 8 depicts an exemplary signal diagram for providing a secure virtual mall, according to one embodiment.

FIG. 9 illustrates an exemplary secure virtual mall with a character visiting a vender.

FIG. 10 illustrates an exemplary computer-implemented method for providing a secure virtual mall, according to one embodiment.

### DETAILED DESCRIPTION

The systems and methods disclosed herein relate to providing a virtual insurance kiosk within a virtual environment, and/or providing a secure virtual mall within a virtual environment.

As used herein, the term virtual environment should be understood to refer to a virtual world, such as a metaverse, a virtual game world, an augmented-reality based virtual world, etc.

As is understood in the art, in some examples, the virtual environment may be accessed by any computing device, such as a computer, a tablet, a smartphone, a virtual reality (VR) headset, an augmented reality (AR) headset, etc.

### Exemplary Virtual Insurance Kiosk System

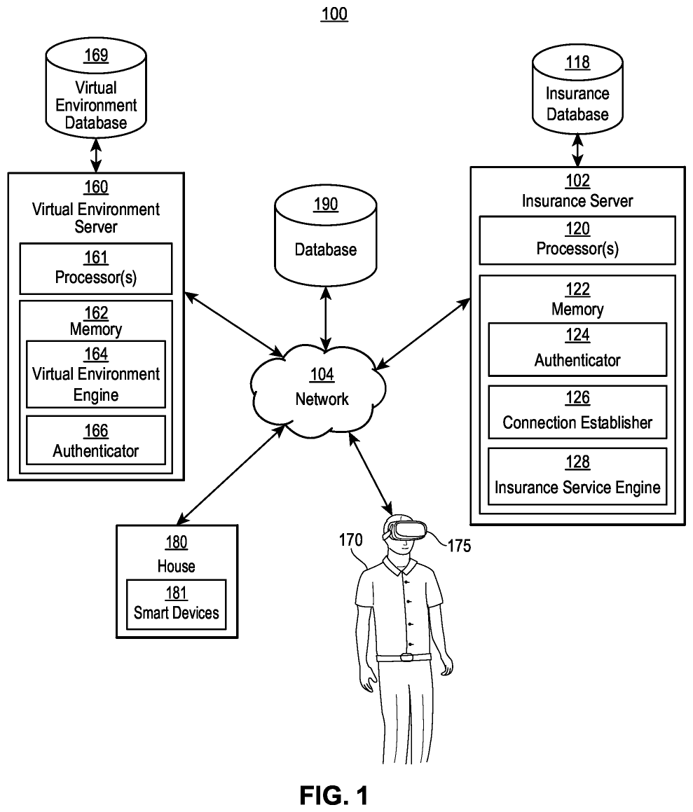

FIG. 1 shows an exemplary virtual insurance kiosk system 100 in which the exemplary computer-implemented methods described herein may be implemented. The high-level architecture includes both hardware and software applications, as well as various data communications channels for communicating data between the various hardware and software components.

Broadly speaking, a virtual environment, such as a metaverse, may be provided by the virtual environment server 160. The virtual environment may allow user-controlled characters (e.g., as represented by avatars in the virtual environment) to traverse the virtual world, interact with each other, gain experience, make purchases for real or virtual items, etc. As referred to herein, purchases refer to purchases made in traditional currency (e.g., U.S. dollars, Euros, etc.), cryptocurrency (e.g., Bitcoin, etc.), virtual currency (e.g., a currency used solely in the virtual world), and/or in exchange for other real or virtual items.

The virtual environment may be provided by the virtual environment server 160. The virtual environment server 160 may include one or more processors 161 such as one or more microprocessors, controllers, and/or any other suitable type of processor. The virtual environment server 160 may further include a memory 162 (e.g., volatile memory, non-volatile memory) accessible by the one or more processors 161, (e.g., via a memory controller). The one or more processors 161 may interact with the memory 162 to obtain and execute, for example, computer-readable instructions stored in the memory 162. Additionally or alternatively, computer-readable instructions may be stored on one or more removable media (e.g., a compact disc, a digital versatile disc, removable flash memory, etc.) that may be coupled to the virtual environment server 160 to provide access to the computer-readable instructions stored thereon.

In particular, the computer-readable instructions stored on the memory 162 may include instructions for executing various applications, such as virtual environment engine 164, and/or an authenticator 166.

In operation, the virtual environment engine 164 may provide the virtual environment. For example, as described elsewhere herein, the virtual environment engine 164 may provide the virtual environment to users such that characters may travel through the virtual environment, interact with each other, gain experience, make purchases, etc.

For instance, a user 170 may wish to participate in the virtual environment. To do so, the user 170 may use a user device 175 (e.g., a virtual reality (VR) headset, a computer, a tablet, a smartphone, an augmented reality (AR) headset, etc.) to access the virtual environment. In this way, the user 170 may create a character to interact with the virtual environment.

The virtual environment engine 164 may store information of the character in the memory 162 and/or the virtual environment database 169. Furthermore, the memory 162 and/or the virtual environment database 169 may store any information related to the virtual environment. For example, the memory 162 and/or the virtual environment database 169, may store information of: characters, buildings, objects (e.g., vehicles, items of the characters, such as tools, weapons, etc.), businesses (e.g., insurance business, such as an insurance business that owns insurance server 102), etc.

To access the virtual environment, in some examples, the user 170 must be authenticated. To this end, the authenticator 166 may authenticate the user 170. As will be described elsewhere herein, the authentication may be based on authentication credentials, such as biometric data received from the user device 175 (e.g., a VR headset automatically gathers biometric data and sends it as part of the authentication process).

Additionally or alternatively to authenticating the user 170, the authenticator 166 may authenticate the insurance server 102. Once authenticated, in some embodiments, the insurance server 102 may be permitted by the virtual environment server 160 to provide a virtual insurance kiosk within the virtual environment. As will be described elsewhere herein, the virtual insurance kiosk may be accessed by the user device 175, and may provide an additional layer of security not normally present within the virtual environment. The virtual insurance kiosk may also provide an insurance service to the user 170, such as purchasing insurance for a virtual item or a real-world item, providing training related to an insurance product, providing a service for filing an insurance claim, etc.

The insurance server 102 may include one or more processors 120 such as one or more microprocessors, controllers, and/or any other suitable type of processor. The insurance server 102 may further include a memory 122 (e.g., volatile memory, non-volatile memory) accessible by the one or more processors 120, (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the insurance server 102 to provide access to the computer-readable instructions stored thereon. In particular, the computer-readable instructions stored on the memory 122 may include instructions for executing various applications, such as authenticator 124, connection establisher 126, and/or insurance service engine 128.

In some embodiments, the insurance server 102 may detect that the user 170 is attempting to interact with the virtual insurance kiosk. For example, a character controlled by the user device 175 may be traveling through the virtual environment, and may approach the virtual insurance kiosk. The insurance server 102 may determine that the user 170 is attempting to interact with the virtual insurance kiosk by, for example, determining that the character controlled by the user device 175 is approaching or has arrived at the virtual insurance kiosk.

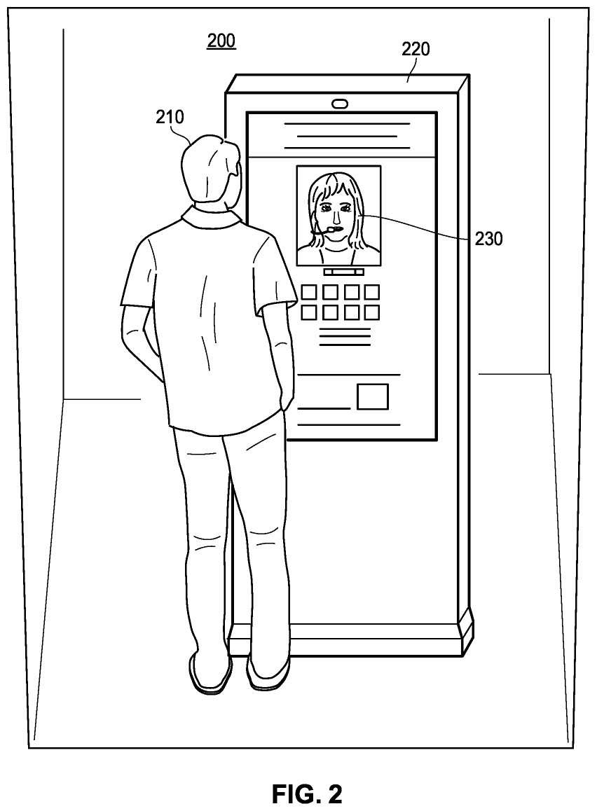

For example, FIG. 2 illustrates an example of virtual character 210 in virtual environment 200 standing at a virtual kiosk 220 with a virtual salesperson 230 standing within the virtual kiosk 220. Thus, in the illustrated example, the insurance server 102 may determine that the virtual character 210 has arrived at the virtual kiosk 220, and thus the user 170 is attempting to interact with the virtual insurance kiosk. As another example, the insurance server 102 may detect that the user 170 is attempting to interact with the virtual insurance kiosk by detecting a virtual interaction with the virtual insurance kiosk.

In response to the insurance server 102 determining that the user 170 is attempting to interact with the virtual insurance kiosk, the authenticator 124 may attempt to authenticate the user device 175. As will be described elsewhere herein, the authentication may be based on authentication credentials, such as biometric data received from the user device 175 (e.g., a VR headset automatically gathers biometric data and sends it as part of the authentication process).

Once the user device 175 is authenticated, the connection establisher 126 may establish a secure connection between the user device 175 and the insurance server 102, thereby connecting the user device 175 to the virtual insurance kiosk. As will be described elsewhere herein, providing the secure connection may include providing a security layer into the secure connection.

Once the secure connection is established, the insurance service engine 128 may provide an insurance service to the user device 175 using the secure connection. For example, once the secure connection is established, the insurance service engine 128 may provide: (i) an offer to purchase insurance for a virtual item, (ii) an offer to purchase insurance for a real-world item, (iii) training related to an insurance product, and/or (iv) a service for filing an insurance claim.

To provide the insurance service, the insurance service engine 128 may use data from any suitable source, such as the insurance database 118. Examples of data maintained at the insurance database 118 and/or used to provide the insurance service include: customer information (e.g., customer profile information, such as a customer's name, address, age, height, weight, gender, etc.), insurance policy information, insurance claim information, etc.

The insurance service engine 128 may also analyze information received from smart devices 181 of house 180. For example, the smart devices 181 may provide information of items in house 180 which are used by the insurance service engine 128 to prepopulate a virtual house that the insurance service engine 128 provides to the user device 175.

In another example, the insurance service engine 128 may analyze information from an external database 190. In the example system 100, the database 190 represents of any entity. For instance, the database 190 may be a database of a store inventory, and the insurance service engine 128 may use information from the database 190 to show potential replacement items (e.g., items to be replaced as part of an insurance claim) to the user 170. Other examples of the database 190 include a public records database, a data aggregator, a database of an insurance company (e.g., the same or different insurance company than a company that owns the insurance server 102).

Further regarding the example system 100, the illustrated example components may be configured to communicate, e.g., via a network 104 (which may be a wired or wireless network, such as the internet), with any other component. Furthermore, although the example system 100 illustrates only one of each of the components, any number of the example components are contemplated (e.g., any number of users, user devices, virtual environment servers, databases, insurance servers, etc.).

### Exemplary Signal Diagram Illustration of Exemplary Provision of a Virtual Insurance Kiosk

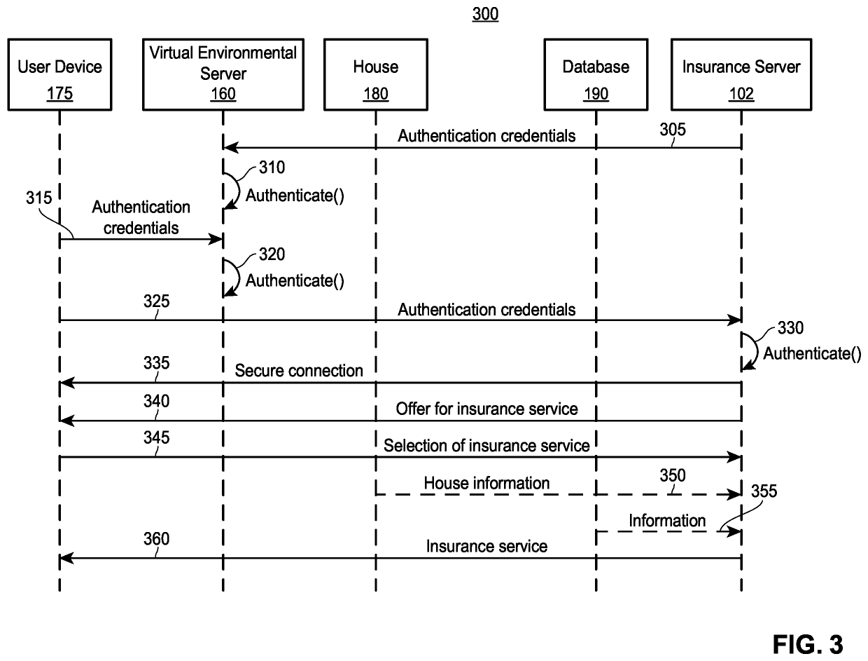

FIG. 3 illustrates an exemplary signal diagram 300 for providing a virtual insurance kiosk, according to an embodiment. More particularly, the signal diagram 300 illustrates the signals exchanged and/or detected by various components of a virtual insurance kiosk system, such as the example virtual insurance kiosk system 100.

The signal diagram 300 begins when the insurance server 102 sends (305) authentication credentials to the virtual environment server 160 (e.g., to allow the insurance server 102 to authenticate with the virtual environment server 160 such that the insurance server 102 may provide the virtual insurance kiosk within the virtual environment). The authentication credentials may comprise any authentication information. For example, the authentication credentials may comprise a user name, password, biometric data of an operator of the insurance server 102 (e.g., fingerprint data, facial recognition data, etc.), a security key that was previously sent to the insurance server 102, etc.

The virtual environment server 160 may then, based upon the authentication credentials received from the insurance server 102, authenticate (310) the insurance server 102 (e.g., via the authenticator 124) with the virtual environment and thereby allowing the insurance server 102 to create and/or deploy the virtual insurance kiosk in the virtual environment hosted by the virtual environment server 160.

The user device 175 also sends (315) authentication credentials to the virtual environment server 160 (e.g., to allow the user 170 to log into the virtual environment). The authentication credentials may comprise any authentication information. For example, the authentication credentials may comprise a user name, password, biometric data (e.g., fingerprint data, facial recognition data, etc.), two-factor authentication information (as will be further described below), a security key that was previously sent to the user device 175, etc. In some examples, where the authentication credentials comprise biometric data, the user device 175 (e.g., a smartphone, tablet, AR headset or glasses, VR headset, smart glasses, etc.) automatically gathers the biometric data (e.g., through a camera or a fingerprint reader of the user device 175), and sends the biometric data to the virtual environment server 160 at 315.

In some examples, the authentication of the user 170 may be two-factor authentication. The two-factor authentication may be completed by any suitable technique. For example, the two-factor authentication may be based upon: (i) a password or passcode, and (ii) biometric data (e.g., fingerprint data, facial recognition data, etc.). Additionally or alternatively, the two-factor authentication may be based upon an authentication code sent to the user device 175. The authentication code may be sent to the user device 175 via any suitable technique, such as by text message, email, voice call, etc. The user device 175 may then send the received authentication code to the virtual environment server 160 as part of completing the two-factor authentication. Thus, although not illustrated in the example signal diagram 300, some embodiments involve multiple transmissions from the user device 175 to the virtual environment server 160.

The virtual environment server 160 may then, based upon the received authentication credentials, authenticate (320) the user 170 (e.g., via the authenticator 124), thereby logging the user 170 into the virtual environment.

The user device 175 may also send (325) authentication credentials to the insurance server 102. The authentication credentials may comprise any authentication information. For example, the authentication credentials may comprise a user name, password, biometric data (e.g., fingerprint data, facial recognition data, etc.), two-factor authentication information, a security key that was previously sent to the user device 175, etc. In some examples, where the authentication credentials comprise biometric data, the user device 175 (e.g., a smartphone, tablet, AR headset, VR headset, etc.) automatically gathers the biometric data (e.g., through a camera or a fingerprint reader of the user device 175), and sends the biometric data to the insurance server 102 at 325.

However, in some examples, the authentication credentials for the insurance server 102 to authenticate the user device 175 with are sent (e.g., at 325) from the virtual environment server 160 (rather than the user device 175). In some such embodiments, the authentication credentials comprise an indication that the virtual environment server 160 successfully authenticated the user 170 (e.g., rather than the underlying data utilized to the authenticate the user 170). This has the advantage that the user 170 then does not have to re-enter authentication information to authenticate with the insurance server 102. However, sending the authentication credentials from the user device 175 has the advantage that it makes it more difficult for the virtual environment server 160 to snoop on the transactions of the user device 175 while authenticated with the insurance server 102.

In some examples, the authentication may be two-factor authentication. The two-factor authentication may be completed by any suitable technique. For example, the two-factor authentication may be based upon: (i) a password or passcode, and (ii) biometric data (e.g., fingerprint data, facial recognition data, etc.). Additionally or alternatively, the two-factor authentication may be based upon an authentication code sent to the user device 175. The authentication code may be sent to the user device 175 via any suitable technique, such as by text message, email, voice call, etc. The user device 175 may then send the received authentication code to the insurance server 102 as part of completing the two-factor authentication. Thus, although not illustrated in the example signal diagram 300, some embodiments involve multiple transmissions from the user device 175 to the insurance server 102.

The insurance server 102 may then, based upon the authentication credentials received from user device 175, authenticate (330) the user 170, thereby permitting the user 170 to interact with the virtual insurance kiosk.

The insurance server 102 (e.g., via the connection establisher 126) may then establish (335) a secure connection with the user device 175 (e.g., via the connection establisher 126). In some embodiments, the secure connection includes a layer of security not present in other parts of the virtual environment. In some examples, the secure connection comprises a communication path that does not traverse the virtual environment server 160. Advantageously, this makes it difficult for the virtual environment server 160 to snoop on transactions conducted as part of the authenticated session between the user device 175 and the insurance server 102 (e.g., transactions conducted within the virtual insurance kiosk).

In one example, the layer of security may be a firewall that blocks sending of particular information outside of the secure connection. For example, the firewall may block the sending of information relating to transactions occurring within the virtual insurance kiosk. Advantageously, this improves computer security by blocking the virtual environment server 160 (or any other entity) from snooping on transactions occurring within the virtual insurance kiosk. Some examples of information that the firewall may block the sending of are any information related to: a purchase of insurance for a virtual item, a purchase of insurance for a real-world item, training related to an insurance product, and a service for filing the insurance claim.

In another example, the layer of security may additionally or alternatively include an encryption layer. For example, the insurance server 102 and/or the user device 175 may generate a public/private key pair for interactions with the virtual insurance kiosk. Accordingly, the insurance server 102 and/or the user device 102 may exchange the public keys. For example, the insurance server 102 may encrypt data using the public key for the user device 175 and the user device 175 may encrypt data using the public key for the insurance server 102. In this example, the insurance server 102 may decrypt data received from the user device 175 and the user device 175 may decrypt data received from the insurance server 102 using their respective private keys. In some embodiments, a new key pair generated by the user device 175 and/or the insurance server 102 each time the user 170 interacts with the virtual insurance kiosk. Advantageously, this improves computer security by blocking the virtual environment server 160 (or any other entity) from snooping on transactions associated with the virtual insurance kiosk.

In yet another example, when sending communications, the insurance server 102 and/or the user device 175 may include a digital signature that is encrypted using a private key of a public/private key pair associated therewith. For instance, the server 102 may apply the corresponding public key of the user device 175 and/or user 170 to the digital signature when receiving communications from the user device 175. Accordingly, the insurance server 102 may only process the received communications if the digital signature is successfully decrypted as determined by the decrypted signature resolving to an expected value.

Upon establishment of the secure connection, the insurance server 102 may provide (340) an offer of an insurance service(s) to the user device 175 (e.g., via the insurance service engine 128). For example, the insurance server may present a user interface within the virtual environment that includes options relating to one or more insurance services, such as: (i) a quote generator for insurance for a virtual item, (ii) a quote generator for insurance for a real-world item, (iii) training related to an insurance product, and/or (iv) filing an insurance claim. Each of these examples (i)-(iv) will be further described below. The communications related to the user interface between the insurance server 102 and the user device 175 may utilize the secure connection.

As a first example, the insurance service may be a quote generator for insurance for a virtual item. Virtual items may be items that exist in the virtual environment (e.g., provided by the virtual environment server 160). Examples of the virtual items include: characters (e.g., represented by avatars), objects for the characters (e.g., cloths, tools, weapons, etc.), vehicles, houses, boats, spaceships, virtual currencies, etc.

For instance, a user 170 may have purchased a virtual item from the virtual environment server 160, and wants to purchase an insurance product to insure the virtual item. For example, the item may be lost for various real-world reasons, such as corruption of data at the virtual environment server 160, a security breach, physical destruction of the virtual environment server 160, etc. In other examples, the virtual item may be lost due to virtual world reasons. In one such example, the virtual item may be a vehicle that is destroyed in a virtual collision within the virtual environment. In another such example, the item may be a house that is destroyed in a virtual fire in the virtual environment. In yet another such example, the virtual item may be a character that is killed in the virtual environment (e.g., by an attack from another character, a car accident, a house fire, etc.).

In a second example, the insurance service comprises a quote generator for insurance for a real-world item. For example, the user 170 may purchase any type of insurance policy for an item that exists in the real world though the virtual insurance kiosk. Examples include an automotive insurance policy, a homeowners insurance policy, a life insurance policy, an umbrella insurance policy, etc.

Purchasing insurance for a real-world item through the virtual insurance kiosk has advantages over purchasing the insurance via other techniques. For example, purchasing via the virtual insurance kiosk may be more convenient because the user 170 is already logged into the virtual environment. It may also be more convenient because the user 170 does not have to look up a phone number or email address of an insurance company (particularly while already logged into the virtual environment). From the insurance company's perspective, the virtual kiosk provides a marketing advantage (e.g., user sees the insurance company's virtual insurance kiosk while navigating through the virtual environment, a virtual avatar associated with the kiosk can be customized based on user preferences derived from usage of the virtual environment, etc.).

Another advantage of providing insurance services through the virtual insurance kiosk is that the services may be protected by one or more additional layers of security. For example, the virtual insurance kiosk may provide an additional layer of encryption, thus providing additional protection against bad actors, bots, etc.

In a third example, the insurance service comprises training related to an insurance product. For example, the training may be training on how to create an inventory list of items that are currently in the insured's house. Such a list is useful in the event of a total loss of the house (e.g., due to fire, natural disaster, etc.). In another example, the training teaches insured how to generate a list of items that have already been destroyed (e.g., again due to fire, natural disaster, etc.).

Again, providing the training in the virtual environment, rather than the real-world, has advantages. For instance, the virtual environment may allow the user 170 to make selections of realistic appearing items to create the inventory list. Additionally, the training materials to be populated with items associated with the insured to provide more relevant examples.

Also advantageous is that the training accomplished via the virtual insurance kiosk may be protected by the layer of security. For example, the virtual insurance kiosk may provide an additional layer of encryption, thus providing additional protection against bad actors, bots, etc.

In some embodiments, the insurance service comprises a service for filing an insurance claim. As with other examples discussed herein, there are advantages to filing an insurance claim via the insurance kiosk. For example, when filed via the insurance kiosk, the filing of the claim is protected by the layer of security (e.g., an additional layer of encryption) provided by the insurance kiosk.

The insurance claim may be any kind of insurance claim. In one example, the insurance claim may be for a virtual item. For instance, a character (e.g., controlled by the user device 175) in the virtual environment may have a virtual car that was destroyed in a car accident in the virtual environment. The character may then travel to the virtual insurance kiosk to place an insurance claim for the car.

In another example, the insurance claim may be for a claim on a real-world insurance policy. For example, if the user's 170 home is destroyed, rather than place an insurance claim by traditional means, the user 170 may control a character in the virtual environment to visit the virtual insurance kiosk to place the insurance claim. Moreover, when placing the insurance claim, the user 170 may include a list of real and/or virtual items that are desired to be replaced. In one such example, the user device 175 may simply send a list of items to the insurance server 102.

At event 345, the user device 175 sends a selection of an insurance service to the insurance server 102. For example, the user device 175 may send an indication that the user 170 wants to generate a quote for insurance of a virtual or real world item. In these examples, the insurance server 102 may guide the user 170 through the quote generation process. As part of the quote generation process, the insurance server 102 may obtain additional information from the user device 175. For example, the user device 175 may send information that the insurance sever 102 uses to determine an insurance quote for a virtual or real world item, such as an identification of the item to insure (e.g., vehicles, electronics, antiques, virtual items, etc.), medical history information (e.g., for use in determining any kind of insurance policy, such as a life insurance policy), and so on.

Additionally, the insurance server 102 may also receive information from other sources. For example, the insurance server 102 may optionally receive house information (350) from house 180. Examples of information received from the house 180 include: images of the inside and/or outside of the house 180, video of the inside and/or outside of the house 180, temperature data of the house, electrical usage of the house, water usage of the house, humidity data of the house, lists of items in the house 180, etc. In some examples, some or all of the house information is gathered by smart devices 181. Examples of the smart devices 181 include smart cameras, smart sensors, smart thermostats, smart appliances, smart sump pumps, etc.

The insurance server 102 may also optionally receive information (355) from a database 190. In one example, the database 190 may be a public records database, and the information received may be property tax information or history of the house 180. In this example, the insurance server may use the property tax information or history to generate a homeowners insurance quote for the user 170.

In another example, the database 190 may be an inventory database of a store that maintains product information for products available via the store. In this example, the insurance server 102 may use the product information to present potential replacement products to the user 170 (e.g., the user's 170 home is a total loss, and the user 170 desires to replace products that were in the home at the time of the loss).

In yet another example, the database 190 may be a database of another insurance company, and the information received may be claims information of the user 170. For example, in some embodiments, the determination of an insurance quote is at least in part based upon a past history of insurance claims by user 170. For instance, if the user 170 has held a homeowners insurance policy for 10 years but never placed a homeowners insurance claim (as shown in the data received from the database 190), the insurance server 102 may determine a less expensive insurance quote for a homeowners insurance policy for the user 170.

The insurance server 102 may create periodic backups of insured virtual items. For example, the item may be a character. The user 170 may spend a large amount of time building the character's experience (e.g., bringing the character to higher levels), and thus it is advantageous for the insurance server 102 to create periodic backups of the character to be used in the event of a loss of the character. In another example, the virtual item may be a vehicle, spaceship, or other type of user-generated property that the user 170 builds in the virtual world. Due to the large amount of time it may take to build the user-generated property, it may be advantageous to create periodic backups.

In some examples where the user 170 has selected a service for filing a homeowners insurance claim, the insurance server 102 may provide the user 170 (e.g., directly to the user device 175 or through the virtual environment server 160) with a virtual house prepopulated with virtual items associated with the corresponding homeowners insurance policy. In some embodiments where the insurance policy does not list specific product identifiers, the prepopulated items are default items of a particular item type maintained at the insurance server 102. On the other hand, if the homeowners insurance policy identifies specific models for the covered items, the prepopulated items may be virtual representations of the specifically-identified models.

Additionally or alternatively, the smart devices 181 may provide information to the insurance server 102 that is used to create the prepopulated default items. For instance, the smart devices 181 may include a smart home controller that generates and sends a list of items populated on the house 180 to the insurance server 102 to prepopulate the virtual house. Additionally or alternatively, the smart devices 181 may include image sensors that capture image data (e.g., images and/or video) to send to the insurance server 102. In response, the insurance server 102 may analyze the image data to determine which items to prepopulate into the virtual house.

In some embodiments, the representation of the virtual house may be based on any known properties of the home maintained in the public databases, such as the database 190 (e.g., square footage, number of bedrooms and/or bathrooms, known floor plan information, construction material information, location information, etc.). In other examples, when the actual floorplan of the house 180 is not known, the virtual house floorplan may be a default floorplan stored by the insurance server 102. For example, if the number of bedrooms and/or bathrooms included in the house 180 is known, the virtual house may be a generic house that has the same number of rooms. Additionally or alternatively, the smart devices 181 may provide information to the insurance server 102 that is used to create the virtual house floorplan. For instance, the smart devices 181 may send imagery information (e.g., images and/or video) that the insurance server 102 analyzes to determine floorplan information.

In some embodiments, the virtual house is presented to the user 170 within the virtual environment as part of providing the insurance service. For example, the insurance server 102 may generate a location within the virtual world that includes a virtual representation of the virtual home. The user 170 may then navigate the virtual house to, for example, modify the virtual house and/or prepopulated. For example, the user device 175 may modify add rooms to or delete rooms from the floorplan of the virtual house. In another example, the user device 175 may add items to or remove items from the virtual house.

Additionally, the user 170 may interact with the virtual house to file a claim or perform other insurance-related activities. For example, the user 170 may identify items populated in the virtual house that have been damaged and should be included in an insurance claim. As another example, the user 170 may identify an item populated in the virtual house not explicitly listed in an insurance policy (e.g., an item populated based on data received from the devices 181) and generate an update form to include the identified items.

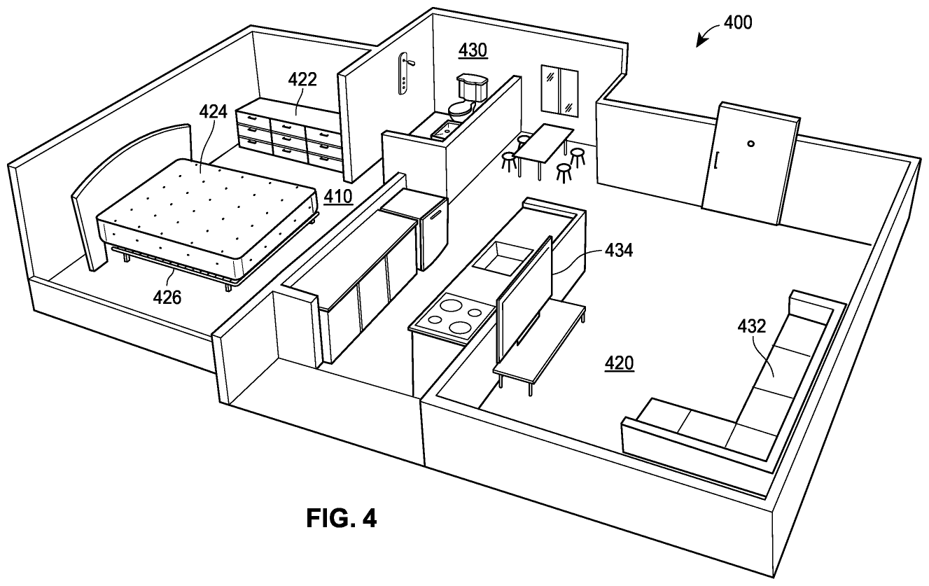

FIG. 4 shows one floor of an example virtual house 400. The example virtual house 400 includes a virtual floorplan with bedroom 410, living room 420, and bathroom 430. The example virtual house 400 has been prepopulated with, in the bedroom, dresser 422, mattress 424, and bedframe 426. As illustrated, the living room 420 in the example virtual house 400 has been prepopulated with, couch 432, and television (TV) 434 which are listed in a homeowner's insurance policy. On the other hand, the bathroom 430 in the example virtual house 400 has not been prepopulated with any items specifically listed in an insurance policy.

Once the example virtual house has been sent to the virtual environment server 160 and provided in the virtual environment, the user device 175 may visit the virtual house and modify the virtual house. For example, the user device 175 may: change the size of any of the rooms 410, 420, 430; remove any of the rooms 410, 420, 430; and/or add additional room(s). The user device 175 may also: remove any of the items 422, 424, 426, 432, 434; replace any of the items 422, 424, 426, 432, 434 (e.g., replace TV 434 with a larger TV).

Moreover, the insurance server 102 may draw information (e.g., from database 190) of the items (e.g., items 422, 424, 426, 432, 434), which may be used to determine the value of each item 422, 424, 426, 432, 434 as part of determining a reimbursement amount of the insurance claim.

Once the necessary information has been gathered, the insurance server 102 may provide (360) the insurance service (e.g., via the insurance service engine 128). For example, the insurance server 102 may send an insurance quote for a virtual or real world item to the user device 175.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Exemplary Methods for Providing a Virtual Insurance Kiosk

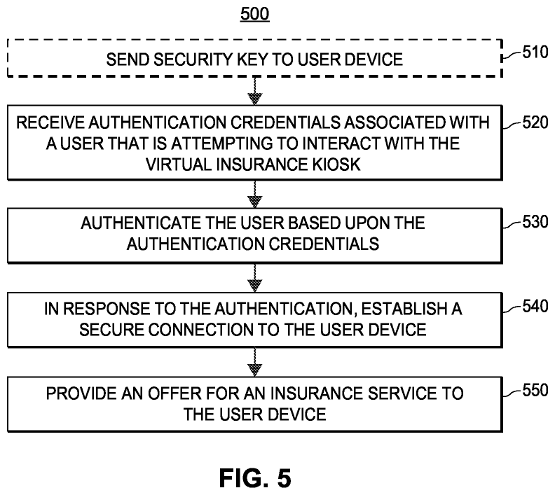

FIG. 5 shows an exemplary computer-implemented method or implementation 500 of providing a virtual insurance kiosk.

The exemplary implementation 500 may begin at optional block 510 when the one or more processors 120 send a security key to the user device 175. In some embodiments, the security key is a unique security key that may be sent back to the insurance server 102 for authentication (e.g., the unique security key is sent back to the insurance server as authentication credentials). In other embodiments, the security key is a public security key, which the user device 175 may use to encrypt communications with so that the insurance server 102 may decrypt the communications with a corresponding private key.

At block 520, the one or more processors 120 receive authentication credentials of the user 170 attempting to interact with the virtual insurance kiosk. In some variations, the one or more processors 120 receive the authentication credentials directly from the user device 175, while in other variations the one or more processors 120 receive the authentication credentials from the virtual environment server 160.

As described above, the authentication credentials may comprise any authentication information. For example, the authentication credentials may comprise a user name, password, biometric data (e.g., fingerprint data, facial recognition data, etc.), two-factor authentication information, a unique security key that was previously sent to the user device 175 at block 510, etc.

At block 530, the one or more processors 120 authenticate the user 170 based upon the authentication credentials. In some embodiments, this includes authenticating the user 170 based upon the unique security key.

At block 540, the one or more processors 120, in response to the authentication, establish a secure connection between the user device 175 and the one or more processors 120. This may include providing a layer of security in the secure connection between the user device 175 and the virtual insurance kiosk. In some implementations, the layer of security comprises a layer of encryption configured to be decrypted with a key private security key corresponding to a public security key associated with the user device 175 and/or insurance server 102.

In some implementations, the layer of security comprises a firewall. And, in some of these implementations, the firewall may block sending outside of the secure connection any information of insurance services provided or offered by the virtual insurance kiosk.

In some implementations, the establishing the secure connection includes establishing a communication path between the one or more processors 120 and the user device that does not traverse a virtual environment server 160.

At block 550, the one or more processors 120 provide an offer for an insurance service to the user device 175 connected to the virtual insurance kiosk.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Applicability to Insurance Rewards Programs

In some examples, using the virtual insurance kiosk may allow an insurance customer to opt-in to a rewards, insurance discount, or other type of program. After the insurance customer provides their affirmative consent, the insurance server 102 may collect data from the user device 175, and/or smart devices 181. The data collected may be related to smart home functionality (or home occupant preferences or preference profiles), and/or insured assets before (and/or after) an insurance-related event, including those events discussed elsewhere herein. In return, risk averse insureds, home owners, or home or apartment occupants may receive discounts or insurance cost savings related to home, renters, personal articles, auto, and other types of insurance from the insurance provider.

In one aspect, smart or interconnected home data, and/or other data, including the types of data discussed elsewhere herein, may be collected or received by the insurance server 102, such as via direct or indirect wireless communication or data transmission from a smart home controller, mobile device, or other customer computing device, after a customer affirmatively consents or otherwise opts-in to an insurance discount, reward, or other program. The insurance provider may then analyze the data received with the customer's permission to provide benefits to the customer. As a result, risk averse customers may receive insurance discounts or other insurance cost savings based upon data that reflects low risk behavior and/or technology that mitigates or prevents risk to (i) insured assets, such as homes, personal belongings, or vehicles, and/or (ii) home or apartment occupants.

### Additional Exemplary Embodiments for Providing a Virtual Insurance Kiosk

In one aspect, a computer-implemented method for providing a virtual insurance kiosk within a virtual environment may be provided. The method may include: (1) receiving, via one or more processors, authentication credentials associated with a user that is attempting to interact with the virtual insurance kiosk within the virtual environment; (2) authenticating, via the one or more processors, the user based upon the authentication credentials; (3) in response to the authentication, establishing, via the one or more processors, a secure connection between a user device of the user and the one or more processors, wherein the establishing the secure connection includes providing a layer of security to support the secure connection between the user device and the virtual insurance kiosk; and/or (4) providing, via the one or more processors and via the secure connection, an offer for an insurance service to the user device connected to the virtual insurance kiosk, wherein the insurance service comprises at least one of: (i) a quote for purchase of insurance for a virtual item, (ii) a quote for purchase of insurance for a real-world item, (iii) training related to an insurance product, and/or (iv) a service for filing an insurance claim. The method may include additional, fewer, or alternate actions, including those discussed elsewhere herein.

In some embodiments, receiving the authentication credentials includes: receiving, via the one or more processors, the authentication credentials directly from the user device.

In some embodiments, receiving the authentication credentials includes: receiving, via the one or more processors, the authentication credentials from a virtual environment server.

In some embodiments, establishing the secure connection includes: establishing, via the one or more processors, a communication path between the one or more processors and the user device that does not traverse a virtual environment server.

In some embodiments, authenticating the user includes: sending, via the one or more processors and to the user device, a security key to be used as the authentication credentials; in response to the user interacting with the virtual insurance kiosk, receiving the security key; and/or verifying, via the one or more processors, the received security key matches the sent security key.

In some embodiments, the authentication credentials include biometric data of the user.

In some embodiments, the layer of security includes a firewall. In certain embodiments, the firewall is configured to block communications outside of the secure connection related to any of: (i) the offer to purchase insurance for the virtual item, (ii) the offer to purchase insurance for the real-world item, (iii) the training related to the insurance product, and/or (iv) the service for filing the insurance claim.

In some embodiments, the insurance service comprises the service for filing an insurance claim, and/or the method may further include: receiving, via the one or more processors, from the user device and via the established secure connection: (i) an indication that the insurance claim is a homeowners insurance claim, (ii) an indication that a home of the insurance claim is a total loss, and/or (iii) a list of items that were in the home at a time of loss.

In some embodiments, the insurance service includes the service for filing an insurance claim, and the method further includes: (a) receiving, via the one or more processors, from the user device and through the established secure connection, an indication that the insurance claim is a homeowners insurance claim; and/or (b) providing, via the one or more processors and in response to receiving the indication that the claim is a home owners insurance claim, a virtual house within the virtual environment and via secure connection, wherein the virtual house is configured to: (i) include prepopulated items associated with a policy related to the homeowners insurance claim, and (ii) allow the user device to add, remove, and/or modify items associated with the virtual house.

In another aspect, a computer system configured to provide a virtual insurance kiosk within a virtual environment, the computer system including one or more processors configured to: (1) receive authentication credentials associated with a user that is attempting to interact with the virtual insurance kiosk within the virtual environment; (2) authenticate the user based upon the authentication credentials; (3) in response to the authentication, establish a secure connection between a user device of the user and the one or more processors, wherein the establishing the secure connection includes providing a layer of security to support the secure connection between the user device and the virtual insurance kiosk; and/or (4) provide, via the secure connection, an offer for an insurance service to the user device connected to the virtual insurance kiosk, wherein the insurance service comprises at least one of: (i) a quote for purchase of insurance for a virtual item, (ii) a quote for purchase of insurance for a real-world item, (iii) training related to an insurance product, and/or (iv) a service for filing an insurance claim. The computer system may include additional, less, or alternate functionality, including that discussed elsewhere herein.

In some embodiments, the one or more processors are further configured to receive the authentication credentials directly from the user device. In some embodiments, the one or more processors are further configured to receive the authentication credentials from a virtual environment server.

In some embodiments, the one or more processors are configured to establish the secure connection by establishing a communication path between the one or more processors and the user device that does not traverse a virtual environment server.

In some embodiments, the one or more processors are further configured to authenticate the user device by: sending, to the user device, a security key to be used as the authentication credentials; in response to the user interacting with the virtual insurance kiosk, receiving the security key; and/or verifying the received security key matches the sent security key.

In yet another aspect, computer device configured to provide a virtual insurance kiosk within a virtual environment may be provided. The computer device may include: one or more processors; and/or one or more memories coupled to the one or more processors. The one or more memories including computer executable instructions stored therein that, when executed by the one or more processors, may cause the one or more processors to: (1) receive authentication credentials associated with a user that is attempting to interact with the virtual insurance kiosk within the virtual environment; (2) authenticate the user based upon the authentication credentials; (3) in response to the authentication, establish a secure connection between a user device of the user and the one or more processors, wherein the establishing the secure connection includes providing a layer of security to support the secure connection between the user device and the virtual insurance kiosk; and/or (4) provide, via the secure connection, an offer for an insurance service to the user device connected to the virtual insurance kiosk, wherein the insurance service comprises at least one of: (i) a quote for purchase of insurance for a virtual item, (ii) a quote for purchase of insurance for a real-world item, (iii) training related to an insurance product, and/or (iv) a service for filing an insurance claim. The computer device may include additional, less, or alternate functionality, including that discussed elsewhere herein.

In some embodiments, the one or more memories including computer executable instructions stored therein that, when executed by the one or more processors, further cause the one or more processors to receive the authentication credentials directly from the user device.

In some embodiments, the one or more memories including computer executable instructions stored therein that, when executed by the one or more processors, further cause the one or more processors to receive the authentication credentials from a virtual environment server.

In some embodiments, the one or more memories including computer executable instructions stored therein that, when executed by the one or more processors, further cause the one or more processors to establish the secure connection by establishing a communication path between the one or more processors and the user device that does not traverse a virtual environment server.

In some embodiments, the one or more memories including computer executable instructions stored therein that, when executed by the one or more processors, further cause the one or more processors to authenticate the user by: sending, to the user device, a security key to be used as the authentication credentials; in response to the user interacting with the virtual insurance kiosk, receiving the security key; and/or verifying the received security key matches the sent security key.

### Exemplary Secure Virtual Mall System

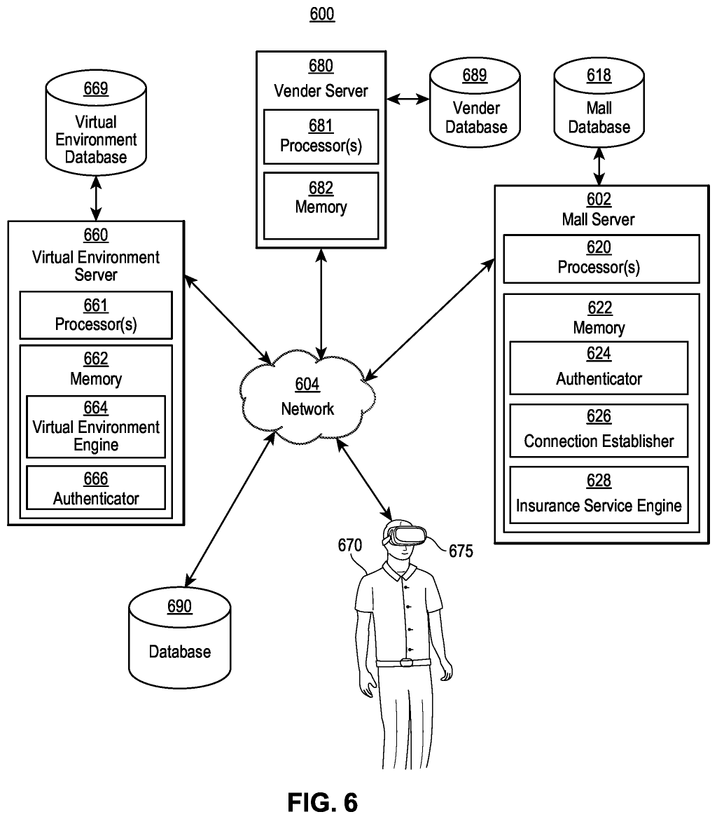

FIG. 6 shows an exemplary secure virtual mall system 600 in which the exemplary computer-implemented methods described herein may be implemented. The high-level architecture includes both hardware and software applications, as well as various data communications channels for communicating data between the various hardware and software components. A virtual environment itself is described elsewhere herein (e.g., with respect to FIG. 1).

In the example system 600, the virtual environment may be provided by the virtual environment server 660. The virtual environment server 660 may include one or more processors 661 such as one or more microprocessors, controllers, and/or any other suitable type of processor. The virtual environment server 660 may further include a memory 662 (e.g., volatile memory, non-volatile memory) accessible by the one or more processors 661, (e.g., via a memory controller). The one or more processors 661 may interact with the memory 662 to obtain and execute, for example, computer-readable instructions stored in the memory 662. Additionally or alternatively, computer-readable instructions may be stored on one or more removable media (e.g., a compact disc, a digital versatile disc, removable flash memory, etc.) that may be coupled to the virtual environment server 660 to provide access to the computer-readable instructions stored thereon. In particular, the computer-readable instructions stored on the memory 662 may include instructions for executing various applications, such as virtual environment engine 664, and/or an authenticator 666.

In operation, the virtual environment engine 664 may provide the virtual environment. For example, as described elsewhere herein, the virtual environment engine 664 may provide the virtual environment to users such that characters may travel through the virtual environment, interact with each other, gain experience, make purchases, etc.

For instance, a user 670 may wish to participate in the virtual environment. To do so, the user 670 may use a user device 675 (e.g., a virtual reality (VR) headset, a computer, a tablet, a smartphone, an augmented reality (AR) headset or glasses, smart glasses, etc.) to access the virtual environment. In this way, it may be the user 670 that creates a character in the virtual environment.

The virtual environment engine 664 may store information of the character in the memory 662 and/or the virtual environment database 669. Furthermore, the memory 662 and/or the virtual environment database 669 may store any information related to the virtual environment. For example, the memory 662 and/or the virtual environment database 669, may store information of: characters, buildings, objects (e.g., vehicles, items of the characters, such as tools, weapons, etc.), businesses (e.g., such as a business that owns vender server 680), etc.

To access the virtual environment, in some examples, the user 670 must be authenticated. To this end, the authenticator 666 may authenticate the user 670. As will be described elsewhere herein, the authentication may be based on authentication credentials, such as biometric data received from the user device 675 (e.g., a VR headset automatically gathers biometric data and sends it as part of the authentication process).

Additionally or alternatively to authenticating the user 670, the authenticator 666 may authenticate a vender corresponding to the vender server 680. Once authenticated, in some embodiments, the vender server 680 may sell items within the virtual environment. In some examples, as will be described elsewhere herein, the vender server 680 may sell items in the secure virtual mall provided by the mall server 602.

The vender server 680 may include one or more processors 681 such as one or more microprocessors, controllers, and/or any other suitable type of processor. The vender server 680 may further include a memory 682 (e.g., volatile memory, non-volatile memory) accessible by the one or more processors 681, (e.g., via a memory controller). The one or more processors 681 may interact with the memory 682 to obtain and execute, for example, computer-readable instructions stored in the memory 682. Additionally or alternatively, computer-readable instructions may be stored on one or more removable media (e.g., a compact disc, a digital versatile disc, removable flash memory, etc.) that may be coupled to the vender server 680 to provide access to the computer-readable instructions stored thereon.

The vender server 680 may also access the vender database 689. Examples of information stored by the vender database include information of: virtual items, real-world items, and/or customers (e.g., user 670, etc.).

The authenticator 666 may also authenticate the mall server 602. Once authenticated, in some embodiments, the mall server 602 may provide a secure virtual mall within the virtual environment. As will be described elsewhere herein, the secure virtual mall may be accessed by the user device 675, and may be permitted by the virtual environment server 660 to provide an additional layer of security not normally present within the virtual environment. The secure virtual mall may also facilitate transactions completed within the virtual mall (e.g., transactions between the user device 675 and the vender server 680). The secure virtual mall may also provide an insurance service to the user device 675, such as by underwriting an insurance product related to a transaction between the user device 675 and the vender server 680, etc.

The mall server 602 may include one or more processors 620 such as one or more microprocessors, controllers, and/or any other suitable type of processor. The mall server 602 may further include a memory 622 (e.g., volatile memory, non-volatile memory) accessible by the one or more processors 620, (e.g., via a memory controller). The one or more processors 620 may interact with the memory 622 to obtain and execute, for example, computer-readable instructions stored in the memory 622. Additionally or alternatively, computer-readable instructions may be stored on one or more removable media (e.g., a compact disc, a digital versatile disc, removable flash memory, etc.) that may be coupled to the mall server 602 to provide access to the computer-readable instructions stored thereon. In particular, the computer-readable instructions stored on the memory 622 may include instructions for executing various applications, such as authenticator 624, connection establisher 626, and/or insurance service engine 628.

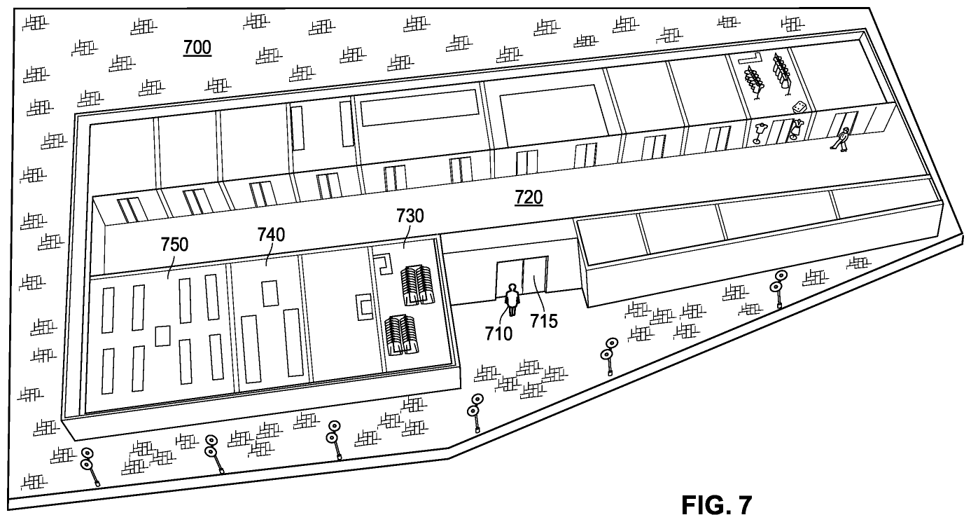

In some embodiments, the mall server 602 may detect that the user 670 is attempting to interact with the secure virtual mall. For example, a character controlled by the user device 675 may be traveling through the virtual environment, and may approach the secure virtual mall. The mall server 602 may determine that the user 670 is attempting to interact with the secure virtual mall by, for example, determining that the character controlled by the user device 675 is attempting to enter the secure virtual mall. For example, FIG. 7 illustrates an exemplary virtual character 710 in virtual environment 700 standing at an entrance 715 of a secure virtual mall 720. The secure virtual mall 720 includes stores 730, 740, 750. Thus, in the illustrated example, because the virtual character 710 has arrived at the entrance 715, the mall server 602 may determine that the virtual character 710 has arrived at the secure virtual mall 720, and thus the user 670 is attempting to interact with the secure virtual mall.

Once the mall server 602 has determined that the user 670 is attempting to interact with the secure virtual mall, the authenticator 624 may attempt to authenticate the user 670. As will be described elsewhere herein, the authentication may be based on user authentication credentials, such as biometric data received from the user device 675 (e.g., a VR headset automatically gathers biometric data and sends it as part of the authentication process).

Once the user device 675 is authenticated, the connection establisher 626 may establish a secure connection between the user device 675 and the mall server 602, thereby connecting the user device 675 to the secure virtual mall. As will be described elsewhere herein, building the secure connection may include building a security layer into the secure connection.

The authenticator 624 may also authenticate a vendor corresponding to the vender server 680. As will be described elsewhere herein, the authentication may be based on vender authentication credentials.

Once the user device 675 is authenticated, the connection establisher 626 may establish a secure connection between the user device 675 and the mall server 602, thereby connecting the user device 675 to the secure virtual mall. As will be described elsewhere herein, building the secure connection may include building a security layer into the secure connection.

Once the secure connections are established, the mall server 602 may process a transaction between the user device 675 and the vender server 680. For example, the mall server 602 may underwrite an insurance product related to the transaction (e.g., a virtual real estate transaction) via the insurance service engine 628). To this end, in some embodiments, the mall server is owned by an insurance company.

Furthermore, the mall server 602 may also receive data from the external database 690, which may be any kind of database. For example, the database 690 may be a public records database, which the mall server 602 uses data from when underwriting the insurance product related to the transaction for the purchase of real-world real estate.

Further regarding the example system 600, the illustrated example components may be configured to communicate, e.g., via a network 604 (which may be a wired or wireless network, such as the internet), with any other component. Furthermore, although the example system 600 illustrates only one of each of the components, any number of the example components are contemplated (e.g., any number of users, user devices, virtual environment servers, mall servers, vender servers, etc.).

### Exemplary Signal Diagram Illustration of Exemplary Provision of a Secure Virtual Mall

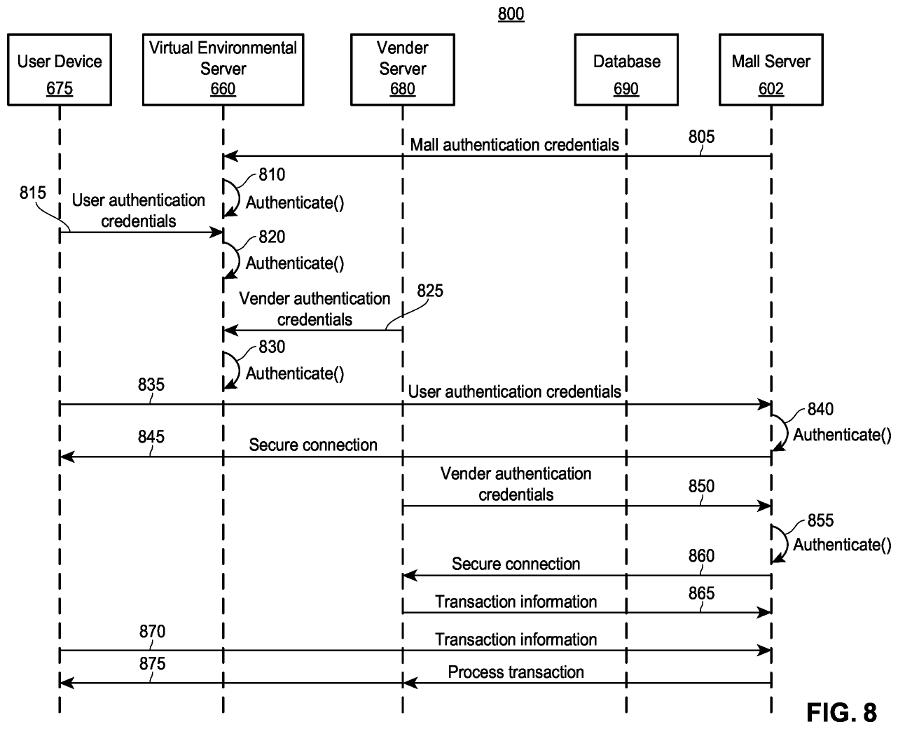

FIG. 8 illustrates an exemplary signal diagram 800 for providing a secure virtual mall, according to an embodiment. More particularly, the signal diagram 800 illustrates the signals exchanged and/or detected by various components of a secure virtual mall system, such as the example secure virtual mall system 800.

The signal diagram 800 begins when the mall server 602 may sends (805) mall authentication credentials to the virtual environment server 660 (e.g., to allow the mall server 602 to authenticate with the virtual environment server 160 so that the insurance server 102 can provide the secure virtual mall within the virtual environment). The mall authentication credentials may comprise any authentication information. For example, the mall authentication credentials may comprise a user name, password, biometric data of an operator of the mall server 602 (e.g., fingerprint data, facial recognition data, etc.), a security key that was previously sent to the mall server 602, etc.

The virtual environment server 660 may then, based upon the authentication credentials received from the mall server 602, authenticate (810) the mall server 602 (e.g., via the authenticator 624), with the virtual environment, thereby allowing the mall server 602 to create, deploy, and/or operate the secure virtual mall in the virtual environment.

The user device 675 sends (815) user authentication credentials to the virtual environment server 660 (e.g., to allow the user 670 to log into the virtual environment). The user authentication credentials may comprise any authentication information. For example, the user authentication credentials may comprise a user name, password, biometric data (e.g., fingerprint data, facial recognition data, etc.), two-factor authentication information (as will be further described below), a security key that was previously sent to the user device 675, etc. In some examples, where the user authentication credentials comprise biometric data, the user device 675 (e.g., a smartphone, tablet, AR headset or glasses, VR headset or glasses, smart glasses or headset, etc.) automatically gathers the biometric data (e.g., through a camera or a fingerprint reader of the user device 675), and sends the biometric data to the virtual environment server 660 at 805.

In some examples, the authentication of the user 670 may be two-factor authentication. The two-factor authentication may be completed by any suitable technique. For example, the two-factor authentication may be based upon: (i) a password or passcode, and (ii) biometric data (e.g., fingerprint data, facial recognition data, etc.). Additionally or alternatively, the two-factor authentication may be based upon an authentication code sent to the user device 675. The authentication code may be sent to the user device 675 via any suitable technique, such as by text message, email, voice call, etc. The user device 675 may then send the received authentication code to the virtual environment server 660 as part of completing the two-factor authentication. Thus, although not illustrated in the example signal diagram 800, some embodiments involve multiple transmissions from the user device 675 to the virtual environment server 660.

The virtual environment server 660 may then, based upon the received user authentication credentials, authenticate (820) the user 670 (e.g., via the authenticator 624), thereby logging the user 670 into the virtual environment.

The vender server 680 may also send (825) vender authentication credentials to the virtual environment server 660 (e.g., to allow the vender server 680 to authenticate with the virtual environment server 660 so that the mall server 602 can provide the secure virtual mall within the virtual environment). The vender authentication credentials may comprise any authentication information. For example, the vender authentication credentials may comprise a user name, password, biometric data of an operator of the vender server 680 (e.g., fingerprint data, facial recognition data, etc.), two-factor authentication information (as will be further described below), a security key that was previously sent to the vender server 680, etc.

In some examples, the authentication of the vender server 680 may be two-factor authentication. The two-factor authentication may be completed by any suitable technique. For example, the two-factor authentication may be based upon: (i) a password or passcode, and (ii) biometric data of an operator of the vender server 680 (e.g., fingerprint data, facial recognition data, etc.). Additionally or alternatively, the two-factor authentication may be based upon an authentication code sent to an operator of the vender server 680. The authentication code may be sent to the operator of the vender server 680 via any suitable technique, such as by text message, email, voice call, etc. The operator of the vender server 680 may then send the received authentication code to the virtual environment server 660 as part of completing the two-factor authentication. Thus, although not illustrated in the example signal diagram 800, some embodiments involve multiple transmissions from the vender server 680 (or operator of the vender server 680) to the virtual environment server 660.

The virtual environment server 660 may then, based upon the authentication credentials received from the vender server 680, authenticate (830) the vender server 680 (e.g., via the authenticator 624), thereby logging the vender server 680 into the virtual environment and allowing the vender server 680 to sell products in the virtual environment (e.g., in the secure virtual mall if the vender server 680 becomes authenticated with the mall server 602; or elsewhere in the virtual environment).

The user device 675 may also send (835) user authentication credentials to the mall server 602. The user authentication credentials may comprise any authentication information. For example, the user authentication credentials may comprise a user name, password, biometric data (e.g., fingerprint data, facial recognition data, etc.), two-factor authentication information, a security key that was previously sent to the user device 675, etc. In some examples, where the authentication credentials comprise biometric data, the user device 675 (e.g., a smartphone, tablet, AR headset, VR headset, etc.) automatically gathers the biometric data (e.g., through a camera or a fingerprint reader of the user device 675), and sends the biometric data to the mall server 602 at 835.

However, in some examples, the user authentication credentials for the mall server 602 to authenticate the user 670 with are sent (e.g., at 835) from the virtual environment server 660 (rather than the user device 675). In some such embodiments, the authentication credentials comprise an indication that the virtual environment server 660 successfully authenticated the user 670 (e.g., rather than comprise, for example, a password). This has the advantage that the user 670 then does not have to re-enter authentication information to authenticate with the mall server 602. However, sending the user authentication credentials from the user device 675 has the advantage that it makes it more difficult for the virtual environment server 660 to snoop on the transactions of the user device 675 while authenticated with the mall server 602.

Furthermore, sending the user authentication credentials directly from the user device 675 to the mall server 602 has the advantage that the user authentication credentials do not need to be stored at the virtual environment server 660. However, the authentication credentials sent from the virtual environment server 660 do not have to be the same as the authentication credentials that would have been sent from the user device 675. In one example, the user device 675, may send biometric authentication credentials to the mall server 602; whereas, to authenticate the user 670, the virtual environment server 660 may send an indication that the user 670 successfully authenticated with the environment server 660.

Once the user authentication credentials are received, the mall server 602 may authenticate (840) the user 670 (e.g., via the authenticator 624) based upon the user authentication credentials.

In some examples, the authentication may be two-factor authentication. The two-factor authentication may be completed by any suitable technique. For example, the two-factor authentication may be based upon: (i) a password or passcode, and (ii) biometric data (e.g., fingerprint data, facial recognition data, etc.). Additionally or alternatively, the two-factor authentication may be based upon an authentication code sent to the user device 675. The authentication code may be sent to the user device 675 via any suitable technique, such as by text message, email, voice call, etc. The user device 675 may then send the received authentication code to the mall server 602 as part of completing the two-factor authentication. Thus, although not illustrated in the example signal diagram 800, some embodiments involve multiple transmissions from the user device 675 to the mall server 602.

The mall server 602 may then, based upon the user authentication credentials received from user device 675, authenticate (840) the user 670, thereby logging the user 670 into the secure virtual mall.

The mall server 602 (e.g., via the connection establisher 626) may then establish (845) a secure connection between the mall server 602 and the user device 675 (e.g., via the connection establisher 626). In some embodiments, the secure connection includes a layer of security not present in other parts of the virtual environment. In some examples, the secure connection comprises a communication path that does not traverse the virtual environment server 660. Advantageously, this makes it difficult for the virtual environment server 660 to snoop on transactions conducted as part of the authenticated session between the user device 675 and the mall server 602 (e.g., transactions conducted within the secure virtual mall).

In one example, the layer of security may be a firewall that blocks sending of particular information outside of the secure connection. For example, the firewall may block the sending of information relating to transactions occurring within the secure virtual mall. Advantageously, this improves computer security by blocking the virtual environment server 660 (or any other entity) from snooping on transactions occurring within the secure virtual mall. Some examples of information that the firewall may block the sending of are: information of transactions that have occurred or are occurring in the secure virtual mall, information of vender servers 660 in the secure virtual mall, information of user devices 675 in the secure virtual mall (e.g., including profile information of users 670 in the secure virtual mall), underwriting information (e.g., of insurance products related to transactions within the secure virtual mall), information of items for sale in the secure virtual mall, a list of user devices 675 currently or previously logged into the secure virtual mall, a list of vender servers 660 currently or previously logged into the secure virtual mall, etc.

In another example, the layer of security may be a layer of encryption added by the mall server 602. Advantageously, similarly to when the security layer comprises a firewall, this improves computer security by blocking the virtual environment server 660 (or any other entity) from snooping on transactions occurring within the secure virtual mall.

The vender server 680 may also send (850) vender authentication credentials to the mall server 602 (e.g., to allow the vender to log into the secure virtual mall and/or sell items in the secure virtual mall). The vender authentication credentials may comprise any authentication information. For example, the vender authentication credentials may comprise a user name, password, biometric data of an operator of the vender server 680 (e.g., fingerprint data, facial recognition data, etc.), two-factor authentication information (as will be further described below), a security key that was previously sent to the vender server 680, etc.

However, in some examples, the vender authentication credentials for the mall server 602 to authenticate a vender corresponding to the vender server 680 with are sent (e.g., at 850) from the virtual environment server 660 (rather than the vender server 680). In some such embodiments, the authentication credentials comprise an indication that the virtual environment server 660 successfully authenticated the vender server 680 (e.g., rather than comprise, for example, a password). This has the advantage that an operator of the vender server 680 then does not have to re-enter authentication information to authenticate with the mall server 602. However, sending the authentication credentials from the vender server 680 has the advantage that it makes it more difficult for the virtual environment server 660 to snoop on the transactions of the vender server 680 while authenticated with the mall server 602.

Furthermore, sending the authentication credentials directly from the vender server 680 to the mall server 602 has the advantage that the credentials do not need to be stored at the virtual environment server 660. However, the authentication credentials sent from the virtual environment server 660 do not have to be the same as the authentication credentials that would have been sent from the vender server 680. In one example, the vender server 680, may send password authentication credentials to the mall server 602; whereas, to authenticate the vender, the virtual environment server 660 may send an indication that the vender server 680 successfully authenticated with the environment server 660.

Once the vender authentication credentials are received, the mall server 602 may authenticate (855) the vender server 680 (e.g., via the authenticator 624) based upon the vender authentication credentials.

In some examples, the authentication may be two-factor authentication. The two-factor authentication may be completed by any suitable technique. For example, the two-factor authentication may be based upon: (i) a password or passcode, and (ii) biometric data of an operator of the vender server 680 (e.g., fingerprint data, facial recognition data, etc.). Additionally or alternatively, the two-factor authentication may be based upon an authentication code sent to an operator of the vender server 680. The authentication code may be sent to the operator of the vender server 680 via any suitable technique, such as by text message, email, voice call, etc. The vender server 680 may then send the received authentication code to the mall server 602 as part of completing the two-factor authentication. Thus, although not illustrated in the example signal diagram 800, some embodiments involve multiple transmissions from the vender server 680 (or operator of the vender server 680) to the mall server 602.

The mall server 602 may then, based upon the vender authentication credentials received from vender server 680, authenticate (855) the vender server 680, thereby logging the vender server 680 into the secure virtual mall.

The mall server 602 (e.g., via the connection establisher 626) may then establish (860) a secure connection between the mall server 602 and the vender server 680 (e.g., via the connection establisher 626). In some embodiments, the secure connection includes a layer of security not present in other parts of the virtual environment. In some examples, the secure connection comprises a communication path that does not traverse the virtual environment server 660. Advantageously, this makes it difficult for the virtual environment server 660 to snoop on transactions conducted as part of the authenticated session between the vender server 680 and the mall server 602 (e.g., transactions conducted within the secure virtual mall).

In one example, the layer of security may be a firewall that blocks sending of particular information outside of the secure connection. For example, the firewall may block the sending of information relating to transactions occurring within the secure virtual mall. Advantageously, this improves computer security by blocking the virtual environment server 660 (or any other entity) from snooping on transactions occurring within the secure virtual mall. Some examples of information that the firewall may block the sending of are: information of transactions that have occurred or are occurring in the secure virtual mall, information of vender servers 660 in the secure virtual mall, information of user devices 675 in the secure virtual mall (e.g., including profile information of users 670 in the secure virtual mall), underwriting information (e.g., of insurance products related to transactions within the secure virtual mall), information of items for sale in the secure virtual mall, a list of user devices 675 currently or previously logged into the secure virtual mall, a list of vender servers 660 currently or previously logged into the secure virtual mall, etc.

In another example, the layer of security may be a layer of encryption added by the mall server 602. Advantageously, similarly to when the security layer comprises a firewall, this improves computer security by blocking the virtual environment server 660 (or any other entity) from snooping on transactions occurring within the secure virtual mall. However, if it is desired that the virtual environment server 660 be able to see transactions occurring within the secure virtual mall, a security key may be provided to the virtual environment server 660. Even with the security key provided to the virtual environment server 660, the security layer is still beneficial because it provides security against entities besides the virtual environment server 660 (e.g., bad actors, and/or unwanted bots).

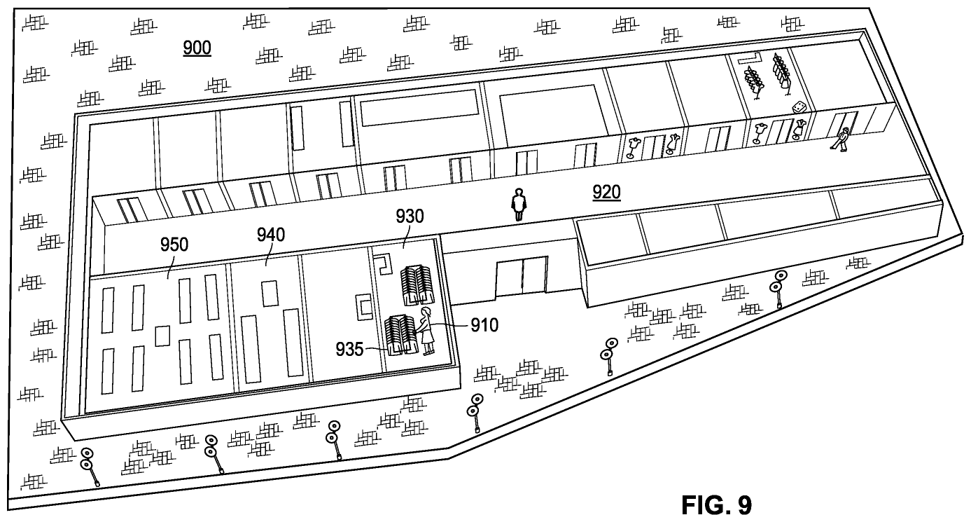

While the user device 675 and vender server 680 are authenticated with the mall server, the user device 675 and vender server 680 may conduct a transaction together within the secure virtual mall. In one illustrative example, FIG. 9 shows character 910 (e.g., controlled by user device 675) visiting the vender 930 (e.g., controlled by the vender server 680) in the secure virtual mall 920 in the virtual environment 900. The example secure virtual mall 920 also includes venders 940 and 950, which may also be controlled by the vender server 675, or may be controlled by different vender servers.

While the character 910 is visiting the vender 930, a transaction may be initiated between the user device 675, and the vender server 680. For example, the character 910 may purchase virtual clothes 935 from the vender 930. However, any kind of transaction is contemplated. Examples of transactions include purchases of virtual items, such as virtual: clothes, shoes, tools, characters, experience points/upgrades to levels of characters, beauty items, real estate (e.g., land with or without structures on it), businesses, cars, boats, books, magazines, food, etc. Other examples of purchases include purchases of real-world items, such as real-world: clothes, shoes, tools, characters, experience points/upgrades to levels of characters, beauty items, real estate (e.g., land with or without structures on it), businesses, cars, boats, books, magazines, food, etc. Because any of these example transactions are conducted within the secure virtual mall, any of these example transactions advantageously gain the benefit of the security layer as discussed herein.

Transaction information may be sent (865) from the vender server 680 to the mall server 602, and sent (870) from the user device 675 to the mall server 602 via the secure connection established at 860. It may be noted that the secure connection established at 860 (e.g., between the vender server 680 and the mall server 602) may be a different secure connection than the secure connection established at 845 (e.g., between the user device 675 and the mall server 602). For example, communications sent through the secure connection established at 845 may be encrypted/decrypted via public/private security key pairs associated the user device 675 and the mall server 602; whereas, communications sent through the connection established at 860 may be encrypted/decrypted via public/private security key pairs associated with the vender server 680 and the mall server 602.

In some embodiments, the mall server 602 verifies that information sent from the user device 675 matches transaction information sent from the vender server 680. For example, if the transaction is for the purchase of virtual real estate, the mall server 602 may verify that the following data matches in the transaction information from the user device 675 and the transaction information from the vender server 680: purchase price, location in the virtual environment, information of a structure on the real estate (e.g., square footage, year built, number of bathrooms, number of bedrooms, etc.), ownership/title information of the real estate information, and/or occupancy information.

In another example, if the transaction is for the purchase of real-world real estate, the mall server 602 may verify that the following data matches in the transaction information from the user device 675 and the transaction information from the vender server 680: purchase price, location in the real-world, information of a structure on the real estate (e.g., square footage, year built, number of bathrooms, number of bedrooms, etc.), ownership/title information of the real estate, and/or occupancy information.

In yet another example, if the transaction if for the purchase of a virtual or real-world vehicle, mall server 602 may verify that the following data matches in the transaction information from the user device 675 and the transaction information from the vender server 680: make, model, year of the vehicle; vehicle identification number (VIN), title information, purchase price, and/or delivery date.

If there is not a match between the information from the user device 675 and the information from the vender server 680, the mall server 602 may reject the transaction. Advantageously, this reduces the possibility of fraud in the transactions in the virtual environment. For example, it is more difficult for a party to claim that they paid a different price than they agreed to if the terms of the transaction were verified by the mall server 602. Moreover, in this example, the mall server 602 improves security by all of: (i) authenticating the user 670; authenticating the vender server 680; and verifying that the information of the transaction from the user device 675 matches the information of the transaction from the vender server 680.

If there is a match between the information from the user device 675 and the information from the vender server 680, the mall server 602 may process (875) the transaction (e.g., via the insurance service engine 628).

In some embodiments, the processing of the transaction also includes creating a backup copy (e.g., at the mall server 602) of the item being purchased. Advantageously, this allows for certain items to be replaced in certain situations. For example, the item may be lost for various real-world reasons, such as corruption of data at the virtual environment server 660, a security breach, physical destruction of the virtual environment server 660, etc. In some examples, the user device 675 pays the mall server 602 to create the backup. For example, the user device 675 may send a request to create a backup of the item (possibly along with payment) at 870.

Additionally or alternatively, the processing of the transaction may also include the mall server 602 underwriting insurance products related to the transaction. For example, the transaction may be a purchase of virtual or real-world real estate. In this example, as part of the transaction, the user computing device 675 may also purchase insurance for the real estate as part of the transaction. For example, at 870, the user device 675 may send a request for purchase (possibly along with payment for the insurance) to the mall server 602. Alternatively, at 870, the user device 675 may send a request for an insurance quote for the real estate, which the user device 675 subsequently accepts or rejects. To this end, in some embodiments, the mall server 602 is a server of an insurance company. Furthermore, any item purchased at part of the transaction may be insured by the mall server 602.

In some embodiments, upon the purchase of an insurance policy, the mall server 602 stores the purchased insurance policy in a profile of the user 670. In addition to the insurance policy, the user profile may include information, such as: the name of the user, past purchase information of the user, and/or an amount of money in a virtual wallet of the user. In some embodiments, the virtual wallet (e.g., including amounts of money therein) is held by the mall server 602. This advantageously makes it more difficult for the virtual environment server 680 and/or the vender server 660 to snoop on the information in the virtual wallet. In some such embodiments, the virtual wallet is accessible to the user device 675 only when the user device 675 is logged into the secure virtual mall.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Exemplary Methods for Providing a Secure Virtual Mall

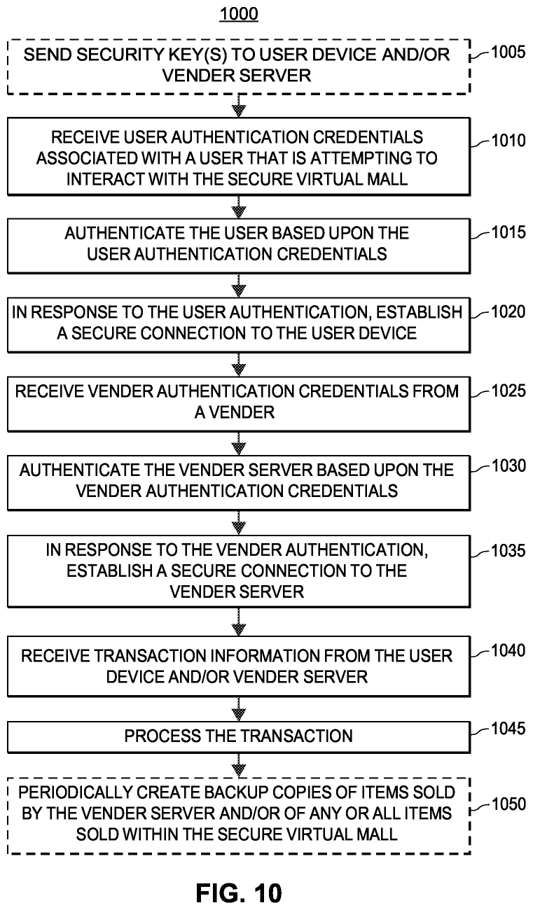

FIG. 10 shows an exemplary computer-implemented method or implementation 1000 of providing a secure virtual mall. The exemplary implementation 1000 may begin at optional block 1005 when the one or more processors 620 send a security key to the user device 675, and/or send a security key to the vender server 660. If security keys are sent to both user device 675, and the vender server 660, the security keys may be the same or different security keys. In some embodiments, the security key(s) are unique security keys that may be sent back to the mall server 602 for authentication (e.g., sent as part of authentication credentials). In other embodiments, the security key(s) are public security key(s), which the user device 675 and/or vender server 660 may use to encrypt communications with so that the mall server 602 may decrypt the communications with a private key corresponding to the public key(s).

At block 1010, the one or more processors 620 receive user authentication credentials from the user 670 that is attempting to interact with the secure virtual mall. In some embodiments, the received user authentication credentials include a unique security key sent to the user device 675 at block 1005. Other user authentication credentials are discussed elsewhere herein.

At block 1015, the one or more processors 620 authenticate the user 670 based upon the user authentication credentials. In some embodiments, this includes authenticating the user 670 based upon the unique security key.

At block 1020, the one or more processors 620, in response to the user authentication, establish a secure connection to the user device 675. In some embodiments, the established connection includes a security layer of encryption configured to be decrypted with a private security key corresponding to the public security key sent at block 1005.

At block 1025, the one or more processors 620 receive vender authentication credentials from the vender server 680 logged into the virtual environment. In some embodiments, the received vender authentication credentials include the security key sent to the vender server 680 at block 1005. Other vender authentication credentials are discussed elsewhere herein.

At block 1030, the one or more processors 620 authenticate a vender corresponding to the vender server 660 based upon the vender authentication credentials.

At block 1035, the one or more processors 620, in response to the vender authentication, establish a secure connection to the vender server 660. In some embodiments, the established connection includes a security layer of encryption configured to be decrypted with a key private security key corresponding to the public security key associated with the vender server 660.

At block 1040, the one or more processors 620 receive transaction information from the user device 675 and/or vender server 660.

At block 1045, the one or more processors 620 process the transaction.

At block 1050, the one or more processors 620 optionally, periodically (e.g., once hourly, once daily, once weekly, etc.) create backup copies of items sold by the vender server and/or of any or all items sold within the secure virtual mall. The backup copies may be stored in the mall database 618 and/or memory 622. Advantageously, storing the backup copies at the database 618 and/or memory 622 makes it more difficult for the virtual environment server 660 to snoop on the backed up data.

The backup copies may be advantageously accessed in the event data of the virtual environment server 660 becomes corrupted, the virtual environment server 660 is hacked, the virtual environment server 660 is destroyed, etc. In some examples, venders may pay a subscription fee to the mall server 602 to have their data periodically backed up. In other examples, the mall server 602 backs up all data of the secure virtual mall (e.g., data of all venders, items, characters, etc.). Thus, in some examples, the entire secure virtual mall (e.g., with all venders, and items of the venders, etc.) may be restored, if necessary.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Applicability to Insurance Rewards Programs

In some examples, using the secure virtual mall may allow an insurance customer (e.g., user 670) to opt-in to a rewards, insurance discount, or other type of program. After the insurance customer provides their affirmative consent, the mall server 602 may collect data from the user device 675. The data collected may be related to actions controlled by the user device 675 in the virtual environment (e.g., purchases made within the virtual mall, actions of characters controlled by the user device 675, etc.). In return, risk averse insureds, home owners, or home or apartment occupants may receive discounts or insurance cost savings related to home, renters, personal articles, auto, and other types of insurance from the insurance provider.

After a customer affirmatively consents or otherwise opts-in to an insurance discount, reward, or other program, the insurance provider (e.g., that owns the mall server 602) may then analyze the data received with the customer's permission to provide benefits to the customer. As a result, risk averse customers may receive insurance discounts or other insurance cost savings based upon data that reflects low risk behavior and/or technology that mitigates or prevents risk to (i) insured assets, such as homes, personal belongings, or vehicles, and/or (ii) home or apartment occupants.

### Additional Exemplary Embodiments for Providing a Secure Virtual Mall

In one aspect, a computer-implemented method for providing a secure virtual mall within a virtual environment may be provided. The method may include: (1) receiving, via one or more processors, user authentication credentials associated with a user that is attempting to interact with the secure virtual mall within the virtual environment; (2) authenticating, via the one or more processors, the user based upon the user authentication credentials; (3) in response to the authentication of the user device, establishing, via the one or more processors, a secure connection between the user device and the one or more processors, wherein the establishing the secure connection includes providing a layer of security within the secure connection between the user device and the secure virtual mall; and/or (4) processing, via the one or more processors, a transaction of the user device occurring in the secure virtual mall, wherein the transaction is between the user device and a vender and is facilitated via the secure connection. The method may include additional, fewer, or alternate actions, including those discussed elsewhere herein.

In some embodiments, processing the transaction includes: receiving, via one or more processors, vender authentication credentials from the vender; and/or authenticating, via the one or more processors, the vender based upon the vender authentication credentials.

In some embodiments, the user is associated with a user profile that indicates: a name of the user; past purchase information of past purchases that the user has made within the secure virtual mall; and/or an amount of currency in a virtual wallet of the user.

In some embodiments, the user device comprises a virtual reality (VR) headset.

In some embodiments, the user authentication credentials comprise biometric data automatically gathered by the VR headset.

In some embodiments, the transaction includes a purchase of: virtual real estate within the virtual environment; real-world real estate; a virtual vehicle within the virtual environment; and/or a real-world vehicle.

In some embodiments, the layer of security comprises a firewall.

In some embodiments, the firewall is configured to block communications outside of the secure connection related to the transaction.

In some embodiments, authenticating the user includes: (i) sending, via the one or more processors, a security key to the user device to use as the authentication credentials; (ii) in response to the user interacting with the secure virtual mall, receiving, via the one or more processors, from the user device, the security key; and/or (iii) verifying, via the one or more processors, the received security key matches the sent security key.

In some embodiments, the method further includes: decrypting, via the one or more processors, a digital signature applied to communications received from the user device using a public key of a public/private key pair associated with the user device.

In some embodiments, processing the transaction may include underwriting an insurance product related to the transaction that the vendor is selling.

In some embodiments, the transaction may include a purchase of virtual real estate and/or a virtual item within the virtual environment; and/or processing the transaction further includes creating a backup copy of the virtual real estate and/or virtual item.

In some embodiments, the method further includes periodically creating backup copies of items sold by the vender.

In some embodiments, processing the transaction may include: (i) determining, via the one or more processors, that transaction information from the user device matches transaction information from the vender; and/or (ii) in response to the determination that the transaction information from the user device matches the transaction information from the vender, processing, via the one or more processors, the transaction.

In another aspect, a computer system configured to provide a secure virtual mall within a virtual environment, the computer system including one or more processors configured to: (1) receive user authentication credentials associated with a user that is attempting to interact with the secure virtual mall within the virtual environment; (2) authenticate the user based upon the user authentication credentials; (3) in response to the authentication of the user device, establish a secure connection between the user device and the one or more processors, wherein the establishing the secure connection includes providing a layer of security within the secure connection between the user device and the secure virtual mall; and/or (4) processes a transaction of the user device occurring in the secure virtual mall, wherein the transaction is between the user device and a vender and is facilitated via the secure connection. The computer system may include additional, less, or alternate functionality, including that discussed elsewhere herein.

In some embodiments, the computer system further includes the user device, and the user device comprises a virtual reality (VR) headset.

In some embodiments, the layer of security includes a firewall that blocks sending outside of the secure connection any information of the transaction being processed in the virtual mall.

In yet another aspect, a computer device configured to provide a secure virtual mall within a virtual environment may be provided. The computer device may include: one or more processors; and/or one or more memories coupled to the one or more processors. The one or more memories including computer executable instructions stored therein that, when executed by the one or more processors, may cause the one or more processors to: (1) receive user authentication credentials associated with a user that is attempting to interact with the secure virtual mall within the virtual environment; (2) authenticate the user based upon the user authentication credentials; (3) in response to the authentication of the user device, establish a secure connection between the user device and the one or more processors, wherein the establishing the secure connection includes providing a layer of security within the secure connection between the user device and the secure virtual mall; and/or (4) processes a transaction of the user device occurring in the secure virtual mall, wherein the transaction is between the user device and a vender and is facilitated via the secure connection. The computer device may include additional, less, or alternate functionality, including that discussed elsewhere herein.

In some embodiments, the one or more memories including computer executable instructions stored therein that, when executed by the one or more processors, further cause the one or more processors to process the transaction further by: receiving vender authentication credentials from the vender; and/or authenticating the vender server based upon the vender authentication credentials. In some embodiments, the user device comprises a virtual reality (VR) headset.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for providing a virtual insurance kiosk within a virtual environment, comprising:
receiving, via one or more processors, authentication credentials associated with a user that is attempting to interact with the virtual insurance kiosk within the virtual environment;
authenticating, via the one or more processors, the user based upon the authentication credentials;
in response to the authentication, establishing, via the one or more processors, a secure connection between a user device of the user and the one or more processors, wherein the establishing the secure connection includes providing a layer of security to support the secure connection between the user device and the virtual insurance kiosk; and
providing, via the one or more processors and via the secure connection, an offer for an insurance service to the user device connected to the virtual insurance kiosk, wherein the insurance service comprises at least one of: (i) a quote for purchase of insurance for a virtual item, (ii) a quote for purchase of insurance for a real-world item, (iii) training related to an insurance product, and/or (iv) a service for filing an insurance claim.

2. The computer implemented of claim 1, wherein receiving the authentication credentials comprises:
receiving, via the one or more processors, the authentication credentials directly from the user device.

3. The computer-implemented method of claim 1, wherein receiving the authentication credentials comprises:
receiving, via the one or more processors, the authentication credentials from a virtual environment server.

4. The computer-implemented method of claim 1, wherein establishing the secure connection comprises:
establishing, via the one or more processors, a communication path between the one or more processors and the user device that does not traverse a virtual environment server.

5. The computer-implemented method of claim 1, wherein authenticating the user comprises:
sending, via the one or more processors and to the user device, a security key to be used as the authentication credentials;
in response to the user interacting with the virtual insurance kiosk, receiving, via the one or more processors, the security key; and
verifying, via the one or more processors, the received security key matches the sent security key.

6. The computer-implemented method of claim 1, wherein the authentication credentials include biometric data of the user.

7. The computer-implemented method of claim 1, wherein the layer of security comprises a firewall.

8. The computer-implemented method of claim 7, wherein the firewall is configured to block communications outside of the secure connection related to any of: (i) the offer to purchase insurance for the virtual item, (ii) the offer to purchase insurance for the real-world item, (iii) the training related to the insurance product, and/or (iv) the service for filing the insurance claim.

9. The computer-implemented method of claim 1, wherein the insurance service comprises the service for filing an insurance claim, and the method further comprises:
receiving, via the one or more processors, from the user device and via the established secure connection: (i) an indication that the insurance claim is a homeowners insurance claim, (ii) an indication that a home of the insurance claim is a total loss, and/or (iii) a list of items that were in the home at a time of loss.

10. The computer-implemented method of claim 1, wherein the insurance service comprises the service for filing an insurance claim, and the method further comprises:
receiving, via the one or more processors, from the user device and through the established secure connection, an indication that the insurance claim is a homeowners insurance claim; and
providing, via the one or more processors and in response to receiving the indication that the claim is a home owners insurance claim, a virtual house within the virtual environment and via secure connection, wherein the virtual house is configured to: (i) include prepopulated items associated with a policy related to the homeowners insurance claim, and (ii) allow the user device to add, remove, and/or modify items associated with the virtual house.

11. A computer system configured to provide a virtual insurance kiosk within a virtual environment, the computer system comprising one or more processors configured to:
receive authentication credentials associated with a user that is attempting to interact with the virtual insurance kiosk within the virtual environment;
authenticate the user based upon the authentication credentials;
in response to the authentication, establish a secure connection between a user device of the user and the one or more processors, wherein the establishing the secure connection includes providing a layer of security to support the secure connection between the user device and the virtual insurance kiosk; and
provide, via the secure connection, an offer for an insurance service to the user device connected to the virtual insurance kiosk, wherein the insurance service comprises at least one of: (i) a quote for purchase of insurance for a virtual item, (ii) a quote for purchase of insurance for a real-world item, (iii) training related to an insurance product, and/or (iv) a service for filing an insurance claim.

12. The computer system of claim 11, wherein the one or more processors are further configured to receive the authentication credentials directly from the user device.

13. The computer system of claim 11, wherein the one or more processors are further configured to receive the authentication credentials from a virtual environment server.

14. The computer system of claim 11, wherein the one or more processors are configured to establish the secure connection by establishing a communication path between the one or more processors and the user device that does not traverse a virtual environment server.

15. The computer system of claim 11, wherein the one or more processors are further configured to authenticate the user device by:
sending, to the user device, a security key to be used as the authentication credentials;
in response to the user interacting with the virtual insurance kiosk, receiving the security key; and
verifying the received security key matches the sent security key.

16. A computer device configured to provide a virtual insurance kiosk within a virtual environment, the computer device comprising:
one or more processors; and
one or more memories coupled to the one or more processors;
the one or more memories including computer executable instructions stored therein that, when executed by the one or more processors, cause the one or more processors to:
receive authentication credentials associated with a user that is attempting to interact with the virtual insurance kiosk within the virtual environment;
authenticate the user based upon the authentication credentials;
in response to the authentication, establish a secure connection between a user device of the user and the one or more processors, wherein the establishing the secure connection includes providing a layer of security to support the secure connection between the user device and the virtual insurance kiosk; and
provide, via the secure connection, an offer for an insurance service to the user device connected to the virtual insurance kiosk, wherein the insurance service comprises at least one of: (i) a quote for purchase of insurance for a virtual item, (ii) a quote for purchase of insurance for a real-world item, (iii) training related to an insurance product, and/or (iv) a service for filing an insurance claim.

17. The computer device of claim 16, wherein the one or more memories including computer executable instructions stored therein that, when executed by the one or more processors, further cause the one or more processors to receive the authentication credentials directly from the user device.

18. The computer device of claim 16, wherein the one or more memories including computer executable instructions stored therein that, when executed by the one or more processors, further cause the one or more processors to receive the authentication credentials from a virtual environment server.

19. The computer device of claim 16, wherein the one or more memories including computer executable instructions stored therein that, when executed by the one or more processors, further cause the one or more processors to establish the secure connection by establishing a communication path between the one or more processors and the user device that does not traverse a virtual environment server.

20. The computer device of claim 16, wherein the one or more memories including computer executable instructions stored therein that, when executed by the one or more processors, further cause the one or more processors to authenticate the user by:
sending, to the user device, a security key to be used as the authentication credentials;
in response to the user interacting with the virtual insurance kiosk, receiving the security key; and
verifying the received security key matches the sent security key.
